(19) United States
(12) Patent Application Publication
(10) Pub. No.: US 2020/0008042 A1
(43) Pub. Date: Jan. 2, 2020

(54) System and Method for the Modification of Extended Idle-Mode Discontinuous Reception (eDRX) Connection Mode

(71) Applicant: Sharp Laboratories of America, Inc., Vancouver, WA (US)

(72) Inventor: Edward Sugiyama, Vancouver, WA (US)

(21) Appl. No.: 16/452,627

(22) Filed: Jun. 26, 2019

Related U.S. Application Data
(63) Continuation of application No. PCT/US19/39009, filed on Jun. 25, 2019.
(60) Provisional application No. 62/690,690, filed on Jun. 27, 2018.

(51) Int. Cl. H04W 8/08; H04W 76/28; H04W 8/24; H04W 60/06; H04W 76/25; H04W 76/30; H04W 76/27; H04W 68/00

(52) U.S. Cl. CPC H04W 8/08; H04W 76/28; H04W 8/24; H04W 68/005; H04W 76/25; H04W 76/30; H04W 76/27; H04W 60/06

(57) ABSTRACT

In a wireless communications network, a system is presented for modifying extended idle-mode Discontinuous Reception (eDRX). The system includes a base station and a wireless terminal/user equipment (UE). A Cellular Internet of Things (CIoT) Core Network (CN) node is also part of the system and includes a Mobility Management Entity (MME) node that receives a downlinked message changing initial UE eDRX parameters to modified UE eDRX parameters, and packages a eDRX change message. The eDRX change message is downlinked to the UE, and the UE replaces the initial eDRX parameters with the modified eDRX parameters in response to the eDRX change message. As a result, the UE and base station are in a connected mode. The modified eDRX parameters may include an eDRX cycle and a Paging Time Window length.

### BACKGROUND OF THE INVENTION

### Field of the Invention

The present disclosure relates generally to communication systems. More specifically, the present disclosure relates to eDRX design for 5th generation (5G) new radio (NR).

### Description of the Related Art

Wireless communication devices have become smaller and more powerful in order to meet consumer needs and to improve portability and convenience. Consumers have become dependent upon wireless communication devices and have come to expect reliable service, expanded areas of coverage, and increased functionality. A wireless communication system may provide communication for a number of wireless communication devices, each of which may be serviced by a base station. A base station may be a device that communicates with wireless communication devices.

In the current Release 15 3GPP specification (23.682), the wireless terminal/user equipment (UE) and network negotiates extended idle-mode DRX (eDRX) power savings parameters. These parameters are transported using non-access stratum (NAS) protocol.

The specification states:
The extended idle mode DRX cycle length requested by UE takes into account requirements of applications running on the UE. Subscription based determination of eDRX cycle length can be used in those rare scenarios when applications on UE cannot be modified to request appropriate extended idle mode DRX cycle length. The network accepting extended DRX while providing an extended idle mode DRX cycle length value longer than the one requested by the UE, can adversely impact reachability requirements of applications running on the UE.

Base Station Substations: eNodeB(eNB)/gNodeB(gNB) along with components of the network architecture such as Mobility Management Entity (MME) are responsible for configuration and implementation of power savings mechanisms.

Currently, user equipments (UEs) transmit requests to obtain power saving parameters. The requests include Attach and Routing/Tracking Area Update. Because these requests are transmitted periodically, battery consumption decreases due to reduced radio transmissions. However, once the UE is in connected mode, power savings parameters such as extended idle-mode DRX cycle (eDRX) are not modified until the next Attach or TAU/RAU requests and responses.

Many Cellular Internet of Things (IoT) devices require long battery life. For Narrow-Band IoT (NB-IoT) and Machine Type Communication (MTC) devices, extended idle-mode Discontinuous Reception (eDRX) is a feature defined by 3GPP to conserve power. eDRX saves power by shutting down the radio for a prolonged period. However, if the UE radio is shutdown, the Core Network (CN) is not able to page the UE. In this case, the UE is not reachable by the network (UE Reachability). eDRX parameters dictate when the UE transitions to listening mode. The listening mode is a period when the UE is reachable by the CN and hence the UE monitors for paging on Narrow Band Physical Downlink Control Channel (NPDCCH).

In a typical IoT use case, a UE transmits Uplink (UL) data to the CN at some interval from few seconds to several days. In between UL transmissions, the UE is in a sleep mode determined by power saving features including eDRX. The UL data eventually reaches to an Application Server to be processed. The Application Server may analyze UL data coming from multiple UEs. The Application Server may reply back with additional data to the UE. The UE eventually resumes back to sleep mode due to lack of data activity. The cycle repeats for the next set of UL data. However in certain circumstances, the Application Server may decide that downlink (DL) data needs to be transmitted to the UE during sleep mode. Unfortunately, the UE is not monitoring for any paging messages and DL data is not be transmitted from the CN. However, there are circumstances that the CN requires transmission of DL data while UE is asleep.

Current Solutions to the problem are as follows:

Negotiate DRX value in the next Tracking Area Update (TAU). The UE can transmit desired eDRX parameters in the Attach/TAU/Routing Area Update (RAU) requests. However, these requests do not get transmitted frequently by the UE. As a result, this solution does not allow immediate modifications to eDRX.

Alternatively, an application in the UE informs the CN by transmitting UL data during sleep period. Typically, the Application Server collects, analyzes, and controls multiple UEs. However, the Application Server may not need, request, or otherwise have use for the UL data, which results in additional power consumption due to additional transmission and processing performed by the UE.

The UE must be in a reachable state before any pages can be received from the CN. The transmission of DL data from CN while the UE is not reachable may be necessary in the following use cases.

Case 1:

UE transmits UL data with unexpected value(s). Based on the data, the Application Server also monitors data from nearby devices to determine if additional actions are necessary. However, the time needed for the Application Server to gather and analyze data from other devices may exceed the data inactivity timer period, so the UE goes back to sleep and becomes unreachable. If the Application Server determines that the data from the UE may be an outlier, a request for another reading is not transmitted to the UE until the next eDRX period.

Case 2:

Based on the collection and analysis of data, the Application Server predicts that an action may be needed at some time in the future. For example, an UE is connected to an agricultural system. Using the data from the UE, the Application Server concludes that a command is needed to turn on/off one of the components before the next eDRX expiration time. However, if the eDRX time is longer than the time for the command to be sent, the UE will not know that the eNB was attempting to page the UE.

Case 3:

The application server determines that a UE requires additional power savings. As a result, to conserve remaining power, the eDRX parameters need to be changed to extend battery life.

Studies have shown that the transmission of data consumes significantly more power than receiving data (monitoring for paging messages). Thus, the reduction of UE data transmission such as Attach/TAU/RAU requests from the UE increases battery life.

It would be advantageous if eDRX parameters could be modified without the use of TAU/RAU requests made by the UE or UE application-driven sleep period UL data transmissions.

### SUMMARY OF THE INVENTION

Disclosed herein are methods for the modification of power saving parameters while a wireless terminal is in the connected mode. The disclosed methods modify power saving features including extended idle-mode Discontinuous Reception (DRX) parameters without the need to transmit additional Attach/Transmit Area Update (TAU)/Routing Real Update (RAU) requests or the need to wait until the end of next eDRX period. These methods also reduce the adverse impact of user equipment (UE) reachability. UE Reachability indicates when the network can send paging along with downlink data to the UE.

Accordingly, in a wireless communications network, a system is presented for modifying extended idle-mode Discontinuous Reception (eDRX). The system includes a base station and a wireless terminal/user equipment (UE). A Cellular Internet of Things (CIoT) Core Network (CN) node is also part of the system and includes a processor and a non-transitory memory. A Mobility Management Entity (MME) node is stored in the non-transitory memory and is enabled as a sequence of processor instructions. The MME receives a downlinked message changing initial UE eDRX parameters to modified UE eDRX parameters, and packages a eDRX change message with the modified eDRX parameters. The eDRX change message is downlinked to the UE, and the UE replaces the initial eDRX parameters with the modified eDRX parameters in response to the eDRX change message. As a result, the UE and base station are in a connected mode. The modified eDRX parameters include an eDRX cycle and a Paging Time Window length.

In one aspect, the MME receives the downlinked change message using special services in a Service Capability Exposure Function (SCEF) message. The MME packages the eDRX change message as part of a Non-Access Stratum (NAS) Detach Request message for transmission to the UE. The UE receives the NAS Detach Request message comprising an Information Element (IE) of modified eDRX parameters. For example, the NAS Detach Request IE may be a 6E Information Element Identifier (IEI).

In another aspect, the MME receives the downlinked change message using special services in a SCEF message, and packages the eDRX change message as part of a UE Context Release message. The CN configures the UE Context Release message for transmission to the base station. The UE Context Release message is packaged inside a Radio Resource Control (RRC) Connection Release message by the base station, and the RRC Connection Release message is transmitted to the UE by the base station.

In another variation, the MME receives the modified eDRX parameters using special services delivered by SCEF, and the MME packages the modified eDRX parameters as part of a dedicatedNASInfo message. Then, the base station transmits a NAS DL (Downlink) Information Transfer message comprising the dedicatedNASInfo message to the UE. That is, the MME packages the NAS DL Information Transfer message with eDRX IE parameters within the dedicatedNASInfo message. The dedicatedNASInfo message parameters include a modified Evolved Packet System Mobility Management (EMM) type message replacing an initial EMM type message, with the modified EMM type message including a eDRX notification, where the eDRX notification includes an Information Element Identifier (WI) value. The Information Elements included in the modified eDRX IEI includes the Length of eDRX parameters, Paging Time Window length, and eDRX cycle value.

Additional details of the above-described communications network and methods of modifying eDRX messages are provided below.

### BRIEF DESCRIPTION OF THE DRAWINGS

FIG. 1 is a block diagram illustrating one implementation of one or more gNBs and one or more UEs in which systems and methods for the modification of extended idle-mode Discontinuous Reception (eDRX) for 5th generation (5G) new radio (NR) may be implemented;

FIG. 2 is a schematic block diagram of an exemplary wireless communications network with a system for modifying eDRX;

FIG. 3 is a flowchart illustrating a method for modifying eDRX in the context of a wireless communications network CIoT CN node comprising a non-transitory memory of processor executable instructions;

FIG. 4 is a flowchart illustrating the method of FIG. 3 in greater detail;

FIG. 5 is a drawing depicting conventional eDRX Configuration;

FIG. 6 is a diagram depicting the modification to an eDRX cycle;

FIG. 7 is a diagram depicting conventional Mobile-Originated (MO) data Transmission;

FIG. 8 is a diagram depicting a NAS Detach Request supporting eDRX configuration;

FIG. 9 is a table depicting the contents of a Detach Request message;

FIG. 10 is a diagram depicting NAS DL Information Transfer supporting eDRX configuration;

FIG. 11 is a drawing depicting a novel EPS Mobility Management (EMM) message type;

FIG. 12 is a diagram depicting extended DRX parameters;

FIG. 13 is a diagram depicting a RRC Connection Release supporting eDRX configuration;

FIG. 14 is a diagram illustrating one example of a resource grid for the downlink;

FIG. 15 is a diagram illustrating one example of a resource grid for the uplink;

FIG. 16 is a diagram illustrating examples of several numerologies;

FIG. 17 is a diagram illustrating examples of subframe structures for the numerologies that are shown;

FIG. 18 is a diagram illustrating examples of slots and sub-slots;

FIG. 19 is a diagram illustrating examples of scheduling timelines;

FIG. 20 is a diagram illustrating examples of downlink (DL) control channel monitoring regions;

FIG. 21 is a diagram illustrating examples of a DL control channel which consists of more than one control channel elements;

FIG. 22 is a diagram illustrating examples of UL control channel structures;

FIG. 23 is a block diagram illustrating one implementation of a gNB;

FIG. 24 is a block diagram illustrating one implementation of a UE;

FIG. 25 illustrates various components that may be utilized in a UE;

FIG. 26 illustrates various components that may be utilized in a gNB;

FIG. 27 is a block diagram illustrating one implementation of a UE in which systems and methods for a long PUCCH design for 5G NR operations may be implemented; and,

FIG. 28 is a block diagram illustrating one implementation of a gNB in which systems and methods for a long PUCCH design for 5G NR operations may be implemented.

### DETAILED DESCRIPTION

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems, and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a user equipment (UE), an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B (3G), an evolved Node B (eNB) or a home enhanced or evolved Node B (HeNB) (4G), or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in the E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and which are allowed by an eNB to transmit or receive information. “Configured cell(s)” may be serving cell(s). The UE may receive system information and perform the required measurements on all configured cells. “Configured cell(s)” for a radio connection may consist of a primary cell and/or no, one, or more secondary cell(s). “Activated cells” are those configured cells on which the UE is transmitting and receiving. That is, activated cells are those cells for which the UE monitors the physical downlink control channel (PDCCH), and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio”, “New Radio Access Technology” or “NR” by 3GPP) envisions the use of time/frequency/space resources to allow for enhanced mobile broadband (eMBB) communication and ultra-reliable low latency communication (URLLC) services, as well as massive machine type communication (mMTC) like services. In order for the services to use the time/frequency/space medium efficiently it would be useful to be able to flexibly schedule services on the medium so that the medium may be used as effectively as possible, given the conflicting needs of URLLC, eMBB, and mMTC. A new radio base station may be referred to as a gNB. A gNB may also be more generally referred to as a base station device.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

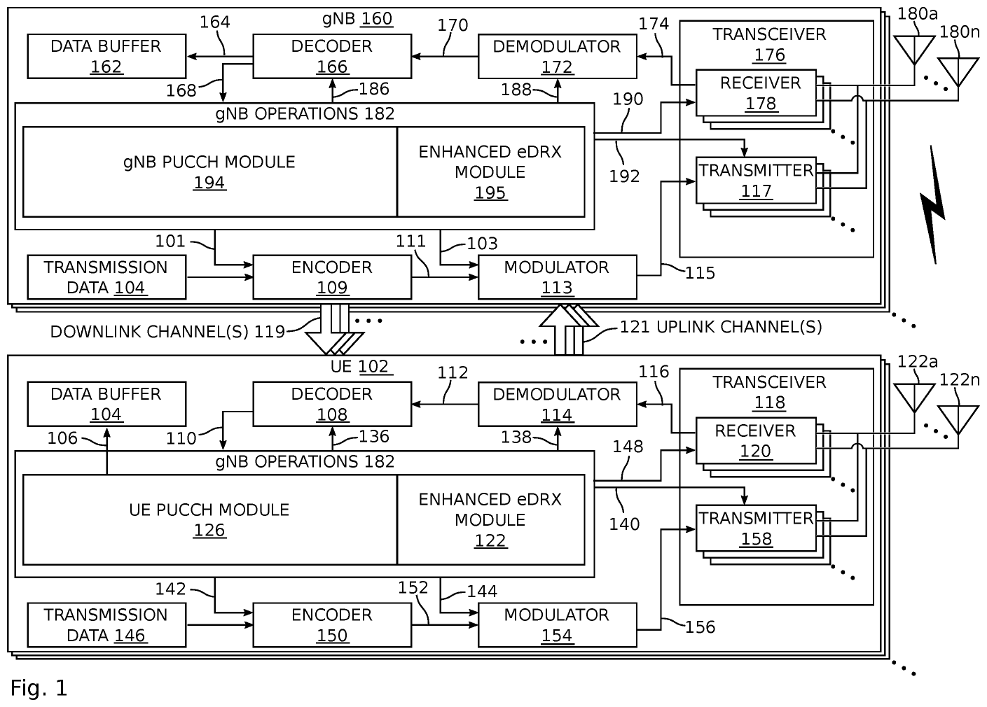

FIG. 1 is a block diagram illustrating one implementation of one or more gNBs 160 and one or more UEs 102 in which systems and methods for the modification of extended idle-mode Discontinuous Reception (eDRX) for 5th generation (5G) new radio (NR) may be implemented. The one or more UEs 102 communicate with one or more gNBs 160 using one or more antennas 122a-n. Alternatively but not shown, the base stations may be eNBs. For example, a UE 102 transmits electromagnetic signals to the gNB 160 and receives electromagnetic signals from the gNB 160 using the one or more antennas 122a-n. The gNB 160 communicates with the UE 102 using one or more antennas 180a-n.

The UE 102 and the gNB 160 may use one or more channels 119, 121 to communicate with each other. For example, a UE 102 may transmit information or data to the gNB 160 using one or more uplink channels 121. Examples of uplink channels 121 include a PUCCH and a PUSCH, etc. The one or more gNBs 160 may also transmit information or data to the one or more UEs 102 using one or more downlink channels 119, for instance. Examples of downlink channels 119 include a PDCCH, a PDSCH, etc. Other kinds of channels may be used.

Each of the one or more UEs 102 may include one or more transceivers 118, one or more demodulators 114, one or more decoders 108, one or more encoders 150, one or more modulators 154, a data buffer 104, and a UE operations module 124. For example, one or more reception and/or transmission paths may be implemented in the UE 102. For convenience, only a single transceiver 118, decoder 108, demodulator 114, encoder 150, and modulator 154 are illustrated in the UE 102, though multiple parallel elements (e.g., transceivers 118, decoders 108, demodulators 114, encoders 150, and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE PUCCH module 126. The UE PUCCH module 126 may include an enhanced eDRX module 127 to implement eDRX modifications and modified eDRX change messages for 5th generation (5G) new radio (NR) as described herein.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH hybrid automatic repeat request acknowledgment (HARQ-ACK) information.

The encoder 150 may encode transmission data 146 and/or other information 142 provided by the UE operations module 124. For example, encoding the data 146 and/or other information 142 may involve error detection and/or correction coding, mapping data to space, time, and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162, and a gNB operations module 182. For example, one or more reception and/or transmission paths may be implemented in a gNB 160. For convenience, only a single transceiver 176, decoder 166, demodulator 172, encoder 109, and modulator 113 are illustrated in the gNB 160, though multiple parallel elements (e.g., transceivers 176, decoders 166, demodulators 172, encoders 109, and modulators 113) may be implemented.

The transceiver 176 may include one or more receivers 178 and one or more transmitters 117. The one or more receivers 178 may receive signals from the UE 102 using one or more antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more antennas 180a-n. For example, the one or more transmitters 117 may upconvert and transmit one or more modulated signals 115. The one or more receivers 178 may further receive information 190 from gNB operations module 182.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include one or more of a gNB PUCCH module 194. The gNB PUCCH module 194 may include an enhanced eDRX module 195 to support the eDRX modifications and signaling for 5G NR as described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time, and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry, or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

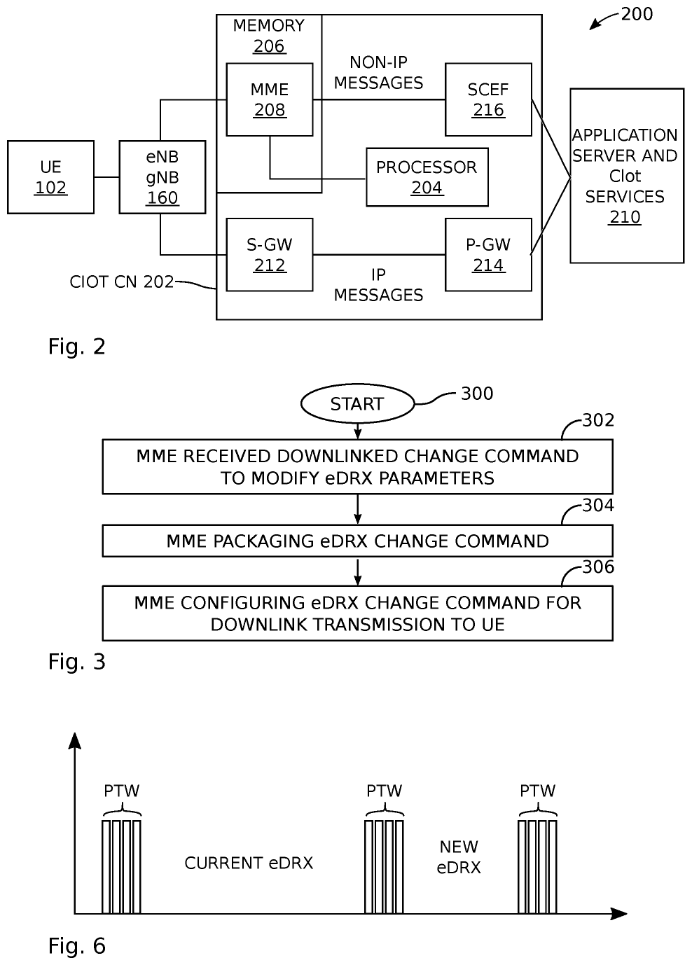

FIG. 2 is a schematic block diagram of an exemplary wireless communications network with a system for modifying eDRX. The system 200 comprises a UE 102, a base station (gNB or eNB) 160, and a Cellular Internet of Things (CIoT) Core Network (CN) node 202. For simplicity only a single UE 102 and a single base station 160 are shown. The CN node 202 includes a processor 204 and a non-transitory memory 206. A Mobility Management Entity (MME) node 208 is stored in the non-transitory memory 206 and enabled as a sequence of processor instructions. Note, although not specifically depicted, software components of the Serving Gateway (S-GW) 212, Packet data Network Gateway (PGW) 214, and Service capability Exposure Function (SCEF) 216 may also reside in memory 206. The MME 208 receives a downlinked message from an Application Server 210 changing initial UE eDRX parameters to modified UE eDRX parameters, and packages a eDRX change message encapsulating the modified eDRX parameters. The eDRX change message is downlinked to the UE 102. The UE 102 replaces the initial eDRX parameters with the modified eDRX parameters in response to the eDRX change message, and as a result, the UE 102 and base station 160 are in a connected mode. Typically, the modified eDRX parameters comprise an eDRX cycle and a Paging Time Window length.

In one aspect, the MME 208 receives the downlinked change message using special services in a Service Capability Exposure Function 216 message, and the MME 208 packages the eDRX change message as part of a Non-Access Stratum (NAS) Detach Request message for transmission to the UE 102. The UE 102 receives the NAS Detach Request message comprising an Information Element (IE) of modified eDRX parameters. For example, the NAS Detach Request IE may be a 6E Information Element Identifier (IEI).

In another aspect, the MME 208 receives the downlinked change message using special services in a SCEF 216 message and packages the eDRX change message as part of a UE Context Release message. The CN 202 thus configures the UE Context Release message for transmission to the base station 160. The modified eDRX parameters, configured as part of the UE Context Release message, are packaged inside a Radio Resource Control (RRC) Connection Release message by the base station 160, and the RRC Connection Release message is transmitted to the UE 102 by the base station.

In another variation, the MME 208 receives the modified eDRX parameters using special services delivered by SCEF 216 and packages the modified eDRX parameters as part of a dedicatedNASInfo message. The base station 160 transmits a NAS DL (Downlink) Information Transfer message comprising the dedicatedNASInfo message to the UE 102. More explicitly, the MME 208 packages the NAS DL Information Transfer message comprising eDRX IE parameters within the dedicatedNASInfo message. Further, the dedicatedNASInfo message parameters comprise a modified Evolved Packet System Mobility Management (EMM) type message replacing an initial EMM type message, with the modified EMM type message comprising a eDRX notification. The eDRX notification comprises an Information Element Identifier (IEI) value, and the Information Elements included in the modified eDRX IEI comprise Length of eDRX parameters, Paging Time Window length, and eDRX cycle value.

FIG. 3 is a flowchart illustrating a method for modifying eDRX in the context of a wireless communications network CIoT CN node comprising a non-transitory memory of processor executable instructions. The method begins at Step 300.

In Step 302 a MME node, stored in the non-transitory memory, receives a downlinked message changing initial UE eDRX parameters to modified UE eDRX parameters. In Step 304 the MME packages an eDRX change message encapsulating the modified eDRX parameters, and in Step 306 the MME configures the eDRX change message for downlink transmission to a UE. Configuring the eDRX change message (Step 306) includes configuring the eDRX change message using one of the following mechanisms: a Non-Access Stratum (NAS) Detach Message, a Downlink (DL) Information Transfer Message, or a Radio Resource Control (RRC) Connection Release Message.

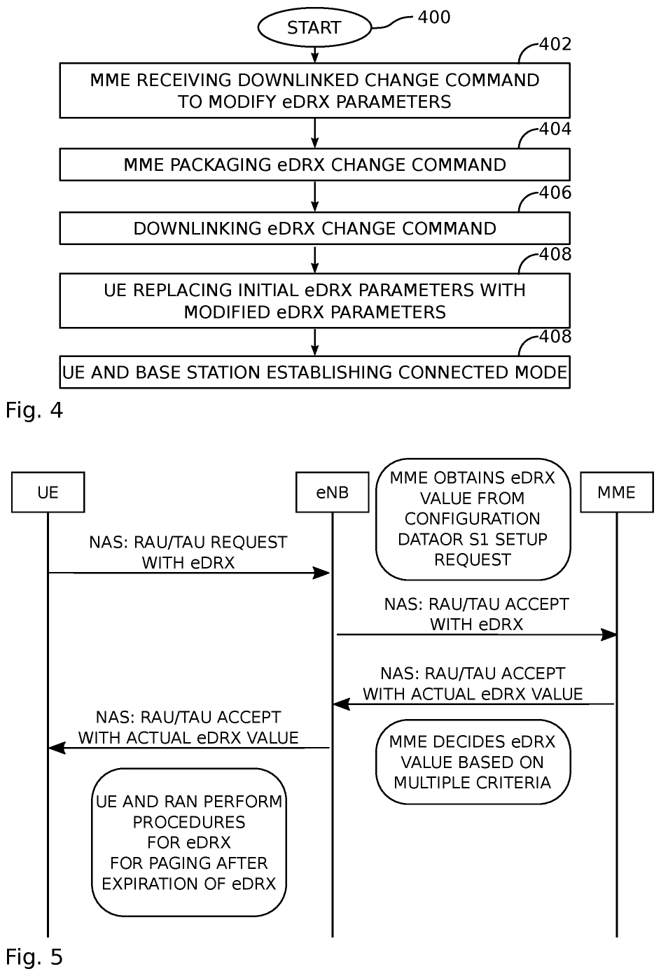

FIG. 4 is a flowchart illustrating the method of FIG. 3 in greater detail. The method starts at Step 400. In Step 402 the MME receives a downlinked message changing initial UE eDRX parameters to modified UE eDRX parameters. The modified eDRX parameters typically comprise an eDRX cycle and a Paging Time Window length. In Step 404 the MME packages an eDRX change message encapsulating the modified eDRX parameters, and in Step 406 the eDRX change message is downlinked to the UE. In Step 408 the UE replaces the initial eDRX parameters with the modified eDRX parameters in response to the eDRX change message. In Step 410 the UE and a base station establish a connected mode.

In one aspect, the MME receiving the downlinked eDRX change message in Step 402 receives the change message using special services in a SCEF message. Then, the MME packaging the eDRX change message in Step 404 packages the eDRX change message as part of a Non-Access Stratum (NAS) Detach Request message for transmission to the UE. Downlinking the eDRX change message to the UE in Step 406 includes the UE receiving the NAS Detach Request message comprising an IE of modified eDRX parameters.

In another aspect, the MME receiving the downlinked change message in Step 402 receives the change message using special services in a SCEF message. The MME packaging the eDRX change message in Step 404 packages the eDRX change message as part of a UE Context Release message, and the CN configures the UE Context Release message for transmission to the base station. Downlinking the eDRX change message to the UE in Step 406 includes configuring the modified eDRX parameters as part of a UE RRC Connection Release message by the base station, and the base station transmitting the RRC Connection Release message to the UE.

In yet another variation, the MME receiving the modified eDRX parameters in Step 402 receives the modified eDRX parameters using special services delivered by SCEF. The MME packaging the modified eDRX parameters in Step 404 packages the modified eDRX parameters as part of a dedicatedNASInfo message. Downlinking the eDRX change message to the UE in Step 406 includes the base station transmitting a NAS DL (Downlink) Information Transfer message comprising the dedicatedNASInfo message.

As described above, system and methods are presented that modify power saving features including extended idle-mode DRX parameters without the need to transmit additional Attach/TAU/RAU requests or wait until the end of next eDRX period. A reduction of eDRX cycle increases the frequency of UE response to paging messages. With IoT devices, the Application Server may require a paging of the UE before the expiration of the eDRX. In contrast, increasing the eDRX value results in longer sleep period of the UE. Hence, the increase in power consumption decreases the battery life.

Some unique aspects of the above-described system and method are:
1) eDRX network parameter configuration using SCEF.
2) Using new eDRX parameters received from SCEF, the MME transmits values to the UE using NAS and RRC messages.
3) NAS messages used for transmission of eDRX parameters include DL Information transport, NAS detach.
4) A RRC Connection Release message may also include eDRX parameters.
5) A new UE Capability message informs of support of eDRX parameters within RRC Connection Release message.
6) The transmission of new eDRX parameters occurs while the UE is in connected mode.
7) An attach request from the UE is not required to acquire new eDRX parameters.
8) TAU/RAU requests from the UE are not needed to acquire new eDRX parameters.

Referring again to FIG. 2, the basic data flow is shown for an UE hosted by an Application Server. Although only one UE is shown, multiple UEs may be connected to a single Application Server. UEs may include NarrowBand IoT (NB-IoT) and Machine Type Communication (MTC) devices. The data flow is as follow:

The UE transmits UL data to (eNB/gNB);

Data packets are separated into Non IP and IP data;

Non IP data is routed to MME->SCEF->Application Server;

IP data is routed to S-GW and P-GW.

Role of SCEF (Service Capability Exposure Function)

3GPP defines (23.682) Non-IP Data Delivery (NIDD) using Service Capability Exposure Function (SCEF). The contents of NIDD may include data from devices such sensor readings, location, and more. The data is processed by the Application Server. One of the SCEF features provides a means to access and expose network capabilities. Network capabilities may include:

Group message delivery

Monitoring of events

Resource management of background data transfer

Network parameter configuration

Network capability information is transferred to MME.

FIG. 5 is a drawing depicting conventional eDRX Configuration. If both the network and UE support eDRX, configuration of eDRX parameters is performed by the MME. The MME obtains eDRX parameters from subscription/configuration information or S1-Setup Request. The UE requests an Attach or TAU/RAU message that contains proposed eDRX parameters. The MME may decide to use the UE requested parameters or a different set of parameters. eDRX parameters from the MME are used for the eDRX power savings mechanism.

Once the UE is released, the device enters sleep mode until the expiration of eDRX cycle. After expiration, UE is ready to monitor paging messages from the eNB/MME.

Because eDRX parameters are updated only by TAU/RAU or Attach requests, the opportunity to modify the parameters during connection state is not conventionally possible. In a typical data transaction between the UE and the CN, there is a data inactivity period. If no data is transmitted or received during this time period, the connection is released. Before the expiration of the data inactivity period, the Application Server determines if modification of eDRX is necessary.

New or modified eDRX parameters are provided by the Application Server to the SCEF during the connected mode. The parameters are transferred to the MME using a new function/capability dedicated to power savings. A T6a/T6b connection is used between SCEF and MME. If the MME confirms that the new eDRX parameters need to change, new eDRX parameters are packaged in a NAS message or transported to RRC Connection Release using S1 Signaling.

FIG. 6 is a diagram depicting the modification to an eDRX cycle. The eDRX parameters include:
Paging Time Window (PTW)—after expiration of eDRX value, time period when network can page the UE.
eDRX value—after expiration of PTW, time period when UE is asleep.

The next cycle of PTW and eDRX is updated if the new eDRX parameters are configured during connected mode. The UE power savings mechanism of the UE can be optimized because eDRX cycle and PTW can be adjusted while connected. With the conventional method, UE does not transmit requests on a regular basis, the eDRX parameters may not change for one eDRX cycle or more.

The following are methods to change eDRX parameters before the UE enters sleep mode:

Detach triggered by MME

DL Information Transfer

RRC Connection Release message

Before the above-described methods are used to modify eDRX parameters, both the network and UE need to support the use of eDRX. The UE performs an initial Attach or TAU/RAU with eDRX parameters in the Information Element. If the network also responds back with eDRX parameters, then eDRX is supported.

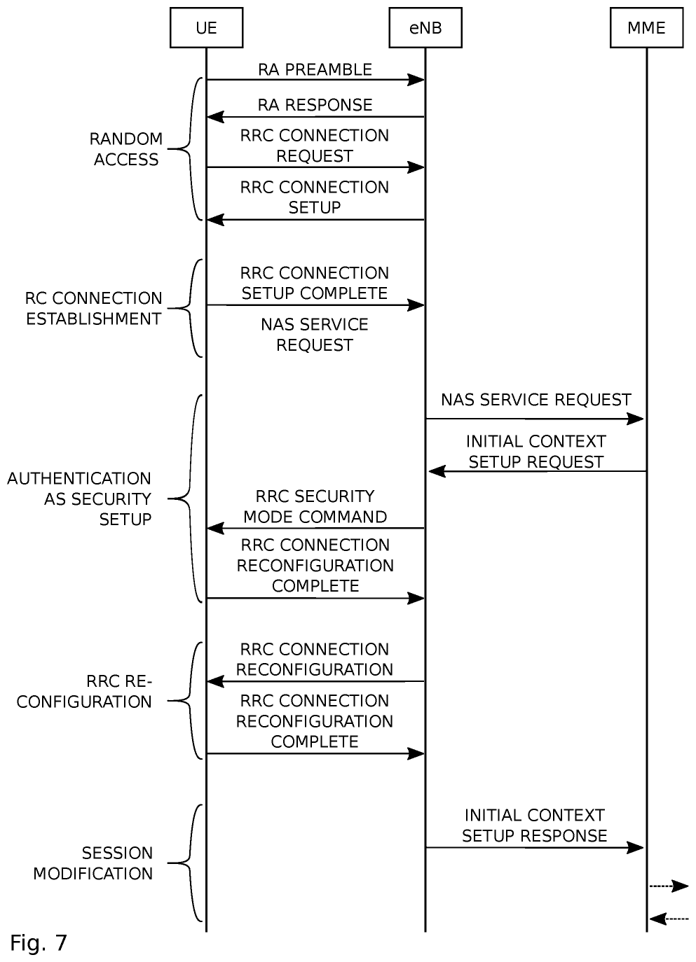

FIG. 7 is a diagram depicting conventional Mobile-Originated (MO) data Transmission.

Detach Triggered by MME

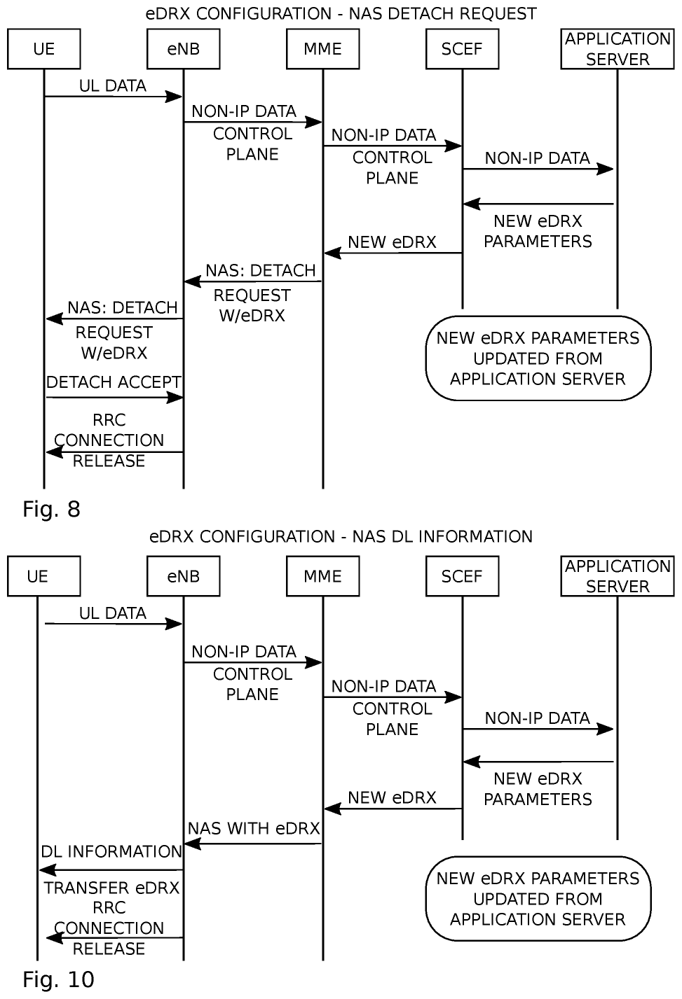

FIG. 8 is a diagram depicting a NAS Detach Request supporting eDRX configuration. If Detach is initiated by MME, a NAS Detach Request message is sent from the MME to UE while in connected mode. eDRX parameters are configured before the Detach Request is sent to the UE. The process for configuring and transmitting new eDRX parameters to the UE is as follow:
1) The UE starts preparation setup process for MO data transport (see FIG. 7).
2) Once setup is complete, the UE is ready to transmit UL data.
3) The UL data is transmitted to the eNB.
4) Non-IP data eventually reaches the Application Server via SCEF and MME.
5) The Application Server analyzes data and determines that an eDRX change is necessary.
6) New eDRX parameters are sent to the MME using special services in SCEF.
7) The MME packages eDRX as part of NAS Detach Request message.
8) A NAS Detach Request message that encapsulates eDRX parameters is transmitted to the UE.
9) Once the connection is released, the UE transitions to sleep mode and eDRX timer starts.

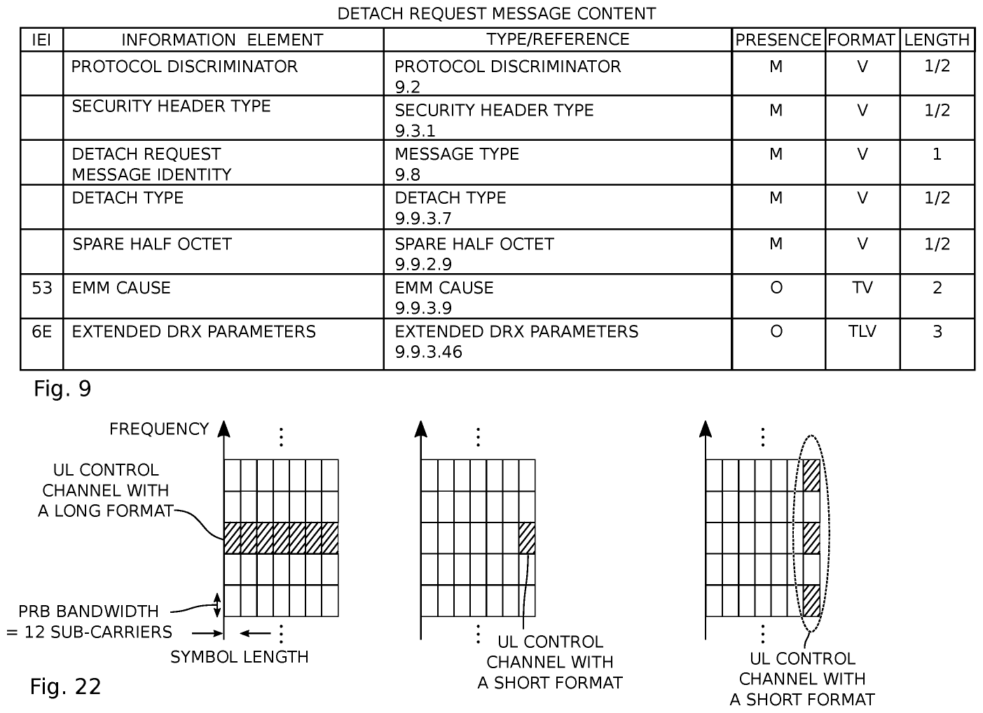

FIG. 9 is a table depicting the contents of a Detach Request message. An IE is Information Element which is analogous to parameters in a message. All messages have an IE which determines what type or what actions the network and/or UE need to perform. In the table, the NAS Detach Message is composed of 5 required type IEs:

Protocol Discriminator

Security header

Detach request message identity

Detach type

Spare half octet

The NAS Detach message can also have additional information such as EMM Cause (what caused the detach request). The bottom row IE is a new Information Element that can also be included in the NAS detach request message. In this case the IEs are the eDRX parameters. eDRX parameters are already conventionally used in other messages, hence the IEI (Information Element Identifier) of 6E. Thus, including the eDRX parameters as part of the NAS detach request is useful.

DL Information Transfer

FIG. 10 is a diagram depicting NAS DL Information Transfer supporting eDRX configuration. DL Information Transfer can also be used to encapsulate a NAS message with new eDRX parameters. Once the MME is ready to send the eDRX value to the UE, a NAS message with eDRX parameters is packed as dedicatedNASInfo and transported using DL Information Transfer procedure.

The process for using DL Information Transfer is as follow:
1) The UE starts preparation setup process for MO data transport.
2) Once setup is complete, the UE is ready to transmit UL data.
3) UL data is transmitted to the eNB.
4) Non-IP data eventually reaches the Application Server via SCEF and MME.
5) The Application Server analyzes data and determines eDRX change is necessary.
6) New eDRX parameters are sent to the MME using special services in SCEF.
7) The MME packages eDRX as a NAS message with eDRX parameters.
8) A DL Information Transfer message carrying NAS message (dedicatedInfoNAS) is sent from the MME to the UE.
9) Once the connection is released, the eDRX timer starts.

Message Type

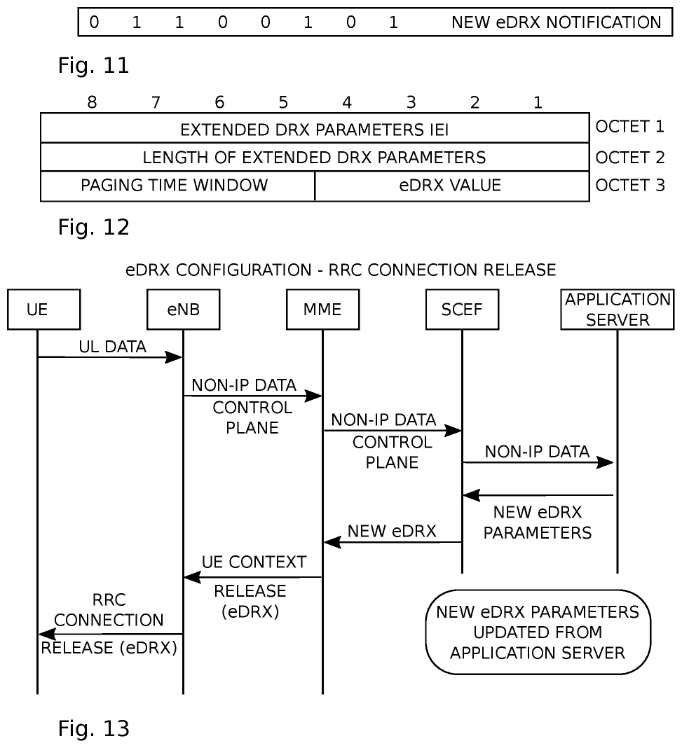

FIG. 11 is a drawing depicting a novel EPS Mobility Management (EMM) message type. The dedicatedNASInfo may consist of the same IE as the Attach/TAU/RAU for eDRX. However, because the UE may not require a new connection, a new EMM message may be is used.

The new eDRX message type EPS Mobility Management is:

Information Element—eDRX parameters

The IE will be the same eDRX parameters

FIG. 12 is a diagram depicting extended DRX parameters. The Extended DRX parameters is a type 4 information element with a length of 3 octets. The Extended DRX parameters information element is coded as shown in FIG. 10.5.5.32/3GPP TS 24.008 and table 10.5.5.32/3GPP TS 24.008. Similar to an Attach/TAU/RAU response, the eDRX parameters received by the UE are implemented. Unlike the requests, there is no negotiation between the UE and network.

RRC Connection Release

FIG. 13 is a diagram depicting a RRC Connection Release supporting eDRX configuration. In the event that NAS Detach Request message is not sent by the network, eDRX parameters may be transmitted to the UE using RRC Connection Release message. Besides the Release Cause, the RRC Connection Release message contains eDRX parameters.

In this method, MME receives new eDRX parameters but has not started the connection release process. Additionally, the MME does not request a NAS Detach message. The process for using RRC Connection Release to modify is as follows:
1) The UE and MME confirm that eDRX is supported from previous Attach or TAU/RAU requests and that the UE and MME support RRC Connection Release messages with eDRX parameters,
2) The UE starts preparation setup process for MO data transport (FIG. 7)
3) The UL data is transmitted to the eNB (FIG. 13).
4) Non-IP data eventually reaches Application Server via SCEF and MME.
5) The Application Server analyzes data and determines eDRX change is necessary.
6) New eDRX parameters are sent to the MME using special services in SCEF.
7) The UE initiates a release since MME does not send a NAS Detach command.
8) The MME packages eDRX parameters as part of UE Context Release message.
9) The eNB receives UE Context Release command from the MME.
10) The eNB transmits the RRC Connection Release message with eDRX parameters to UE.
11) Once the connection is released, the UE transitions to sleep mode and eDRX timer starts.

Both the UE and network need to support eDRX parameters in a RRC Connection Release message. Confirmation is achieved by using UE Capability. The UE capability message contains an IE with an “eDRX in RRC Connection Release flag” enabled. If the network supports the feature, the RRC Connection Release contains eDRX parameters. If the network does not support the eDRX feature, the RRC Connection Release received by the UE will not contain any eDRX parameters in the IE.

Information Element (IE) for RRC Connection Release-NB

```
RRCConnectionRelease-NB-r13-IEs ::= SEQUENCE {
    releaseCause-r13,
    resumeIdentity-r13, OPTIONAL, -- Need OR
    extendedWaitTime-r13, INTEGER (1..1800) OPTIONAL, --
Need ON
    redirectedCarrierInfo-r13 OPTIONAL, -- Need ON
    lateNonCriticalExtension OCTET STRING OPTIONAL,
    nonCriticalExtension RRCConnectionRelease-NB-vXXX-IEs
OPTIONAL
}
RRCConnectionRelease-NB-vXXX-IEs ::= SEQUENCE {
    eDRXParamSupport-r13
    nonCriticalExtension SEQUENCE { } OPTIONAL
}
```

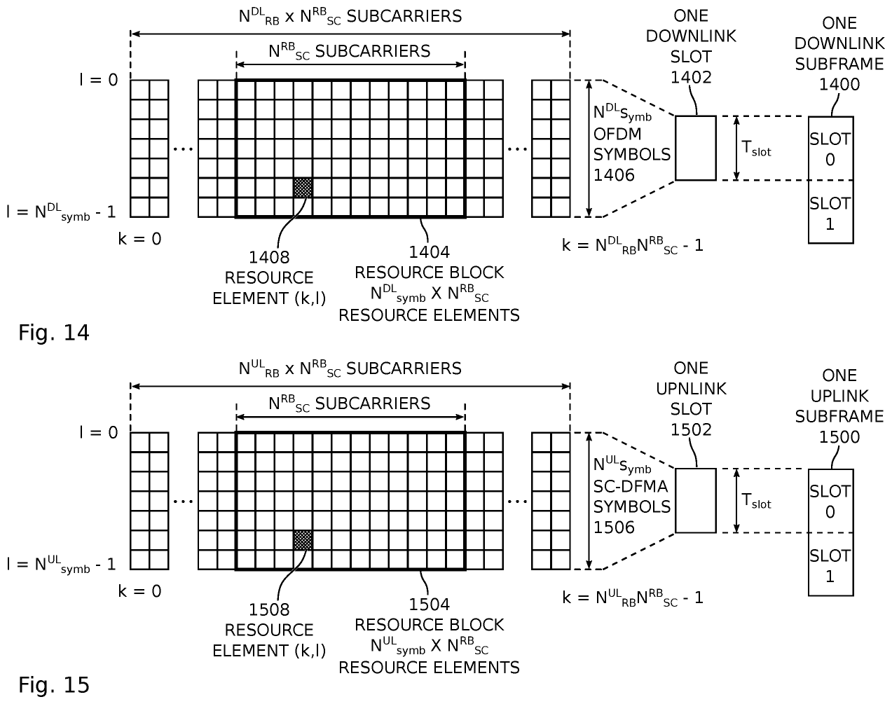

FIG. 14 is a diagram illustrating one example of a resource grid for the downlink. The resource grid illustrated may be utilized in some implementations of the systems and methods disclosed herein. More detail regarding the resource grid is given in connection with FIG. 1.

In FIG. 14, one downlink subframe 1400 may include two downlink slots 1402. N^{DL}_{RB} is downlink bandwidth configuration of the serving cell, expressed in multiples of N^{RB}_{sc}, where N^{RB}_{sc} is a resource block 1404 size in the frequency domain expressed as a number of subcarriers, and N^{DL}_{symb} is the number of OFDM symbols 1406 in a downlink slot 1402. A resource block 1404 may include a number of resource elements (RE) 1408.

For a PCell, N^{DL}_{RB} is broadcast as a part of system information. For an SCell (including a license assisted access (LAA) SCell), N^{DL}_{RB} is configured by a RRC message dedicated to a UE 102. For PDSCH mapping, the available RE 1408 may be the RE 1408 whose index l fulfils l≥l_{data,start} and/or l_{data,end}≥l in a subframe.

In the downlink, the OFDM access scheme with cyclic prefix (CP) may be employed, which may be also referred to as CP-OFDM. In the downlink, PDCCH, enhanced downlink physical control channel (EPDCCH), PDSCH and the like may be transmitted. A downlink radio frame may consist of multiple pairs of downlink resource blocks (RBs) which is also referred to as physical resource blocks (PRBs). The downlink RB pair is a unit for assigning downlink radio resources, defined by a predetermined bandwidth (RB bandwidth) and a time slot. The downlink RB pair consists of two downlink RBs that are continuous in the time domain.

The downlink RB consists of twelve sub-carriers in the frequency domain and seven (for normal CP) or six (for extended CP) OFDM symbols in time domain. A region defined by one sub-carrier in the frequency domain and one OFDM symbol in the time domain is referred to as a resource element (RE) and is uniquely identified by the index pair (k,l) in a slot, where k and l are indices in the frequency and time domains, respectively. While downlink subframes in one component carrier (CC) are discussed herein, downlink subframes are defined for each CC and downlink subframes are substantially in synchronization with each other among CCs.

FIG. 15 is a diagram illustrating one example of a resource grid for the uplink. The resource grid illustrated may be utilized in some implementations of the systems and methods disclosed herein. More detail regarding the resource grid is given in connection with FIG. 1.

In FIG. 15, one uplink subframe 1500 may include two uplink slots 1502. N^{UL}_{RB} is uplink bandwidth configuration of the serving cell, expressed in multiples of N^{RB}_{sc}, where N^{RB}_{sc} is a resource block 1504 size in the frequency domain expressed as a number of subcarriers, and N^{UL}_{symb} is the number of SC-FDMA symbols 1506 in an uplink slot 1083. A resource block 1504 may include a number of resource elements (RE) 1508.

For a PCell, N^{UL}_{RB} is broadcast as a part of system information. For an SCell (including an LAA SCell), N^{UL}_{RB} is configured by a RRC message dedicated to a UE 102.

In the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). In the uplink, PUCCH, PDSCH, physical random access channel (PRACH) and the like may be transmitted. An uplink radio frame may consist of multiple pairs of uplink resource blocks. The uplink RB pair is a unit for assigning uplink radio resources, defined by a predetermined bandwidth (RB bandwidth) and a time slot. The uplink RB pair consists of two uplink RBs that are continuous in the time domain.

The uplink RB may consist of twelve sub-carriers in the frequency domain and seven (for normal CP) or six (for extended CP) OFDM/DFT-S-OFDM symbols in the time domain. A region defined by one sub-carrier in the frequency domain and one OFDM/DFT-S-OFDM symbol in the time domain is referred to as a RE and is uniquely identified by the index pair (k,l) in a slot, where k and l are indices in the frequency and time domains respectively. While uplink subframes in one component carrier (CC) are discussed herein, uplink subframes are defined for each CC.

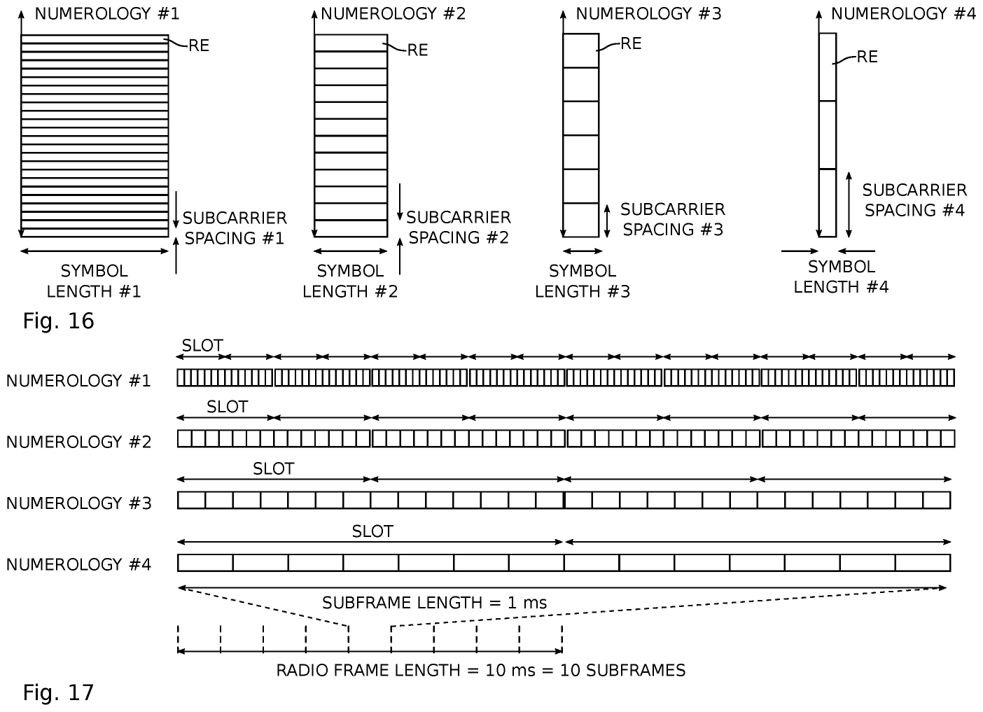

FIG. 16 is a diagram illustrating examples of several numerologies. The numerology #1 may be a basic numerology. For example, a RE of the basic numerology is defined with subcarrier spacing of 15 kHz in frequency domain and 2048 Ts+CP length (e.g. 160 Ts or 144 Ts) in time domain, where Ts denotes a baseband sampling time unit defined as 1/(15000*2048) seconds. For the i-th numerology, the subcarrier spacing may be equal to 15*2ⁱ and the effective OFDM symbol length 2048*2⁻ⁱ*Ts. It may cause the symbol length is 2048*2⁻ⁱ*Ts+CP length (e.g. 160*2⁻ⁱ*Ts or 144*2⁻ⁱ*Ts). In other words, the subcarrier spacing of the i+1-th numerology is a double of the one for the i-th numerology, and the symbol length of the i+1-th numerology is a half of the one for the i-th numerology. The system may support a number of numerologies. Furthermore, the system does not have to support all of the 0-th to the I-th numerologies, i=0, 1, . . . , I.

FIG. 17 is a diagram illustrating examples of subframe structures for the numerologies that are shown. Given that a slot consists of N^{DL}_{symb} (or N^{UL}_{symb})=7 symbols, the slot length of the i+1-th numerology is a half of the one for the i-th numerology, and eventually the number of slots in a subframe (i.e., 1 ms) becomes double. It may be noted that a radio frame may consists of 10 subframes, and the radio frame length may be equal to 10 ms.

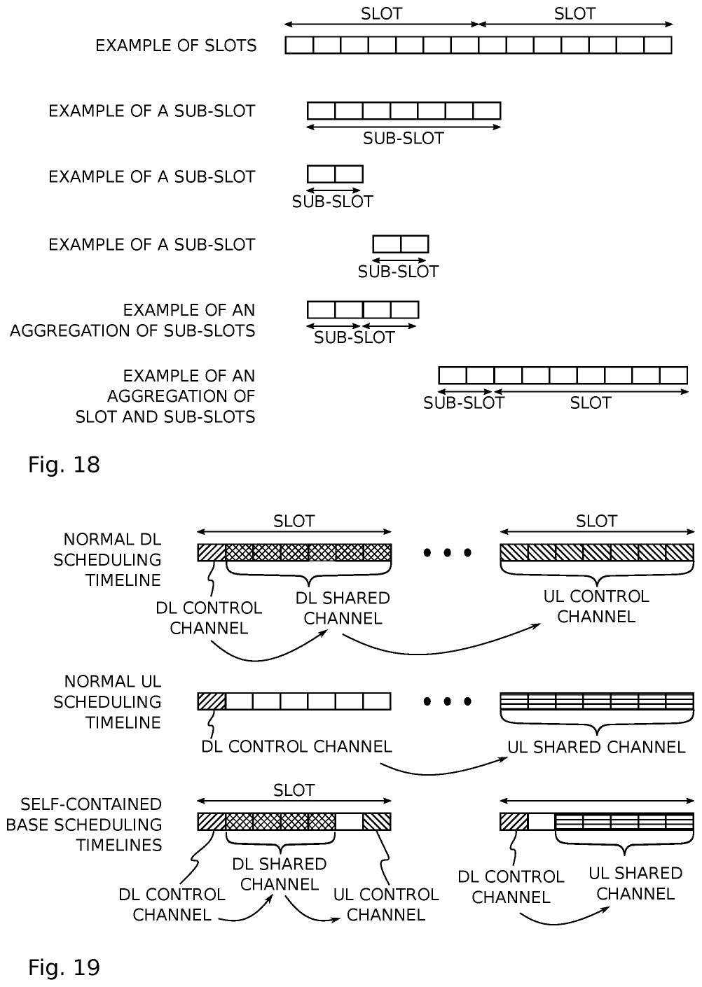

FIG. 18 is a diagram illustrating examples of slots and sub-slots. If sub-slot is not configured by higher layer, the UE 102 and the eNB/gNB 160 may only use a slot as a scheduling unit. More specifically, a given transport block may be allocated to a slot. If the sub-slot is configured by higher layer, the UE 102 and the eNB/gNB 160 may use the sub-slot as well as the slot. The sub-slot may consist of one or more OFDM symbols. The maximum number of OFDM symbols that constitute the sub-slot may be N^{DL}_{symb}−1 (or N^{UL}_{symb}−1).

The sub-slot length may be configured by higher layer signaling. Alternatively, the sub-slot length may be indicated by a physical layer control channel (e.g. by DCI format).

The sub-slot may start at any symbol within a slot unless it collides with a control channel. There could be restrictions of mini-slot length based on restrictions on starting position. For example, the sub-slot with the length of N^{DL}_{symb}−1 (or N^{UL}_{symb}−1) may start at the second symbol in a slot. The starting position of a sub-slot may be indicated by a physical layer control channel (e.g. by DCI format). Alternatively, the starting position of a sub-slot may be derived from information (e.g. search space index, blind decoding candidate index, frequency and/or time resource indices, PRB index, a control channel element index, control channel element aggregation level, an antenna port index, etc.) of the physical layer control channel which schedules the data in the concerned sub-slot.

In cases when the sub-slot is configured, a given transport block may be allocated to either a slot, a sub-slot, aggregated sub-slots, or aggregated sub-slot(s) and slot. This unit may also be a unit for HARQ-ACK bit generation.

FIG. 19 is a diagram illustrating examples of scheduling timelines. For a normal DL scheduling timeline, DL control channels are mapped to the initial part of a slot. The DL control channels schedule DL shared channels in the same slot. HARQ-ACKs for the DL shared channels (i.e. HARQ-ACKs each of which indicates whether or not transport block in each DL shared channel is detected successfully) are reported via UL control channels in a later slot. In this instance, a given slot may contain either one of DL transmission and UL transmission. For a normal UL scheduling timeline, DL control channels are mapped to the initial part of a slot. The DL control channels schedule UL shared channels in a later slot. For these cases, the association timing (time shift) between the DL slot and the UL slot may be fixed or configured by higher layer signaling. Alternatively, it may be indicated by a physical layer control channel (e.g. the DL assignment DCI format, the UL grant DCI format, or another DCI format such as UE-common signaling DCI format which may be monitored in common search space).

For a self-contained base DL scheduling timeline, DL control channels are mapped to the initial part of a slot. The DL control channels schedule DL shared channels in the same slot. HARQ-ACKs for the DL shared channels are reported in UL control channels which are mapped at the ending part of the slot. For a self-contained base UL scheduling timeline, DL control channels are mapped to the initial part of a slot. The DL control channels schedule UL shared channels in the same slot. For these cases, the slot may contain DL and UL portions, and there may be a guard period between the DL and UL transmissions.

The use of a self-contained slot may be based upon a configuration of the self-contained slot. Alternatively, the use of a self-contained slot may be based upon a configuration of the sub-slot. Yet alternatively, the use of a self-contained slot may be upon a configuration of shortened physical channel (e.g. PDSCH, PUSCH, PUCCH, etc.).

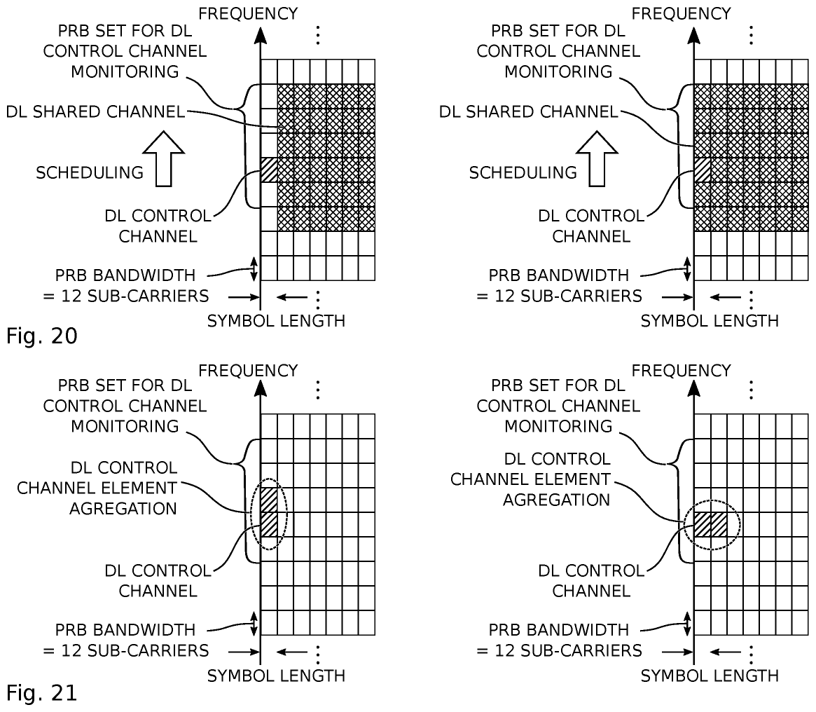

FIG. 20 is a diagram illustrating examples of DL control channel monitoring regions. One or more sets of PRB(s) may be configured for DL control channel monitoring. In other words, a control resource set is, in the frequency domain, a set of PRBs within which the UE 102 attempts to blindly decode downlink control information, where the PRBs may or may not be frequency contiguous, a UE 102 may have one or more control resource sets, and one DCI message may be located within one control resource set. In the frequency-domain, a PRB is the resource unit size (which may or may not include demodulation reference signal (DM-RS)) for a control channel. A DL shared channel may start at a later OFDM symbol than the one(s) which carries the detected DL control channel. Alternatively, the DL shared channel may start at (or earlier than) an OFDM symbol than the last OFDM symbol which carries the detected DL control channel. In other words, dynamic reuse of at least part of the resources in the control resource sets for data for the same or a different UE 102, at least in the frequency domain may be supported.

FIG. 21 is a diagram illustrating examples of a DL control channel which consists of more than one control channel elements. When the control resource set spans multiple OFDM symbols, a control channel candidate may be mapped to multiple OFDM symbols or may be mapped to a single OFDM symbol. One DL control channel element may be mapped on REs defined by a single PRB and a single OFDM symbol. If more than one DL control channel element is used for a single DL control channel transmission, DL control channel element aggregation may be performed.

The number of aggregated DL control channel elements is referred to as DL control channel element aggregation level. The DL control channel element aggregation level may be 1 or 2 to the power of an integer. The gNB 160 may inform a UE 102 of which control channel candidates are mapped to each subset of OFDM symbols in the control resource set. If one DL control channel is mapped to a single OFDM symbol and does not span multiple OFDM symbols, the DL control channel element aggregation is performed within an OFDM symbol, namely multiple DL control channel elements within an OFDM symbol are aggregated. Otherwise, DL control channel elements in different OFDM symbols can be aggregated.

FIG. 22 is a diagram illustrating examples of UL control channel structures. UL control channels may be mapped on REs which are defined as a PRB and a slot in the frequency and time domains, respectively. This UL control channel may be referred to as a long format (or just the 1st format). UL control channels may be mapped on REs on a limited OFDM symbols in time domain. This may be referred to as a short format (or just the 2nd format). The UL control channels with a short format may be mapped on REs within a single PRB. Alternatively, the UL control channels with a short format may be mapped on REs within multiple PRBs. For example, interlaced mapping may be applied, namely the UL control channel may be mapped to every N PRBs (e.g. 5 or 10) within a system bandwidth.

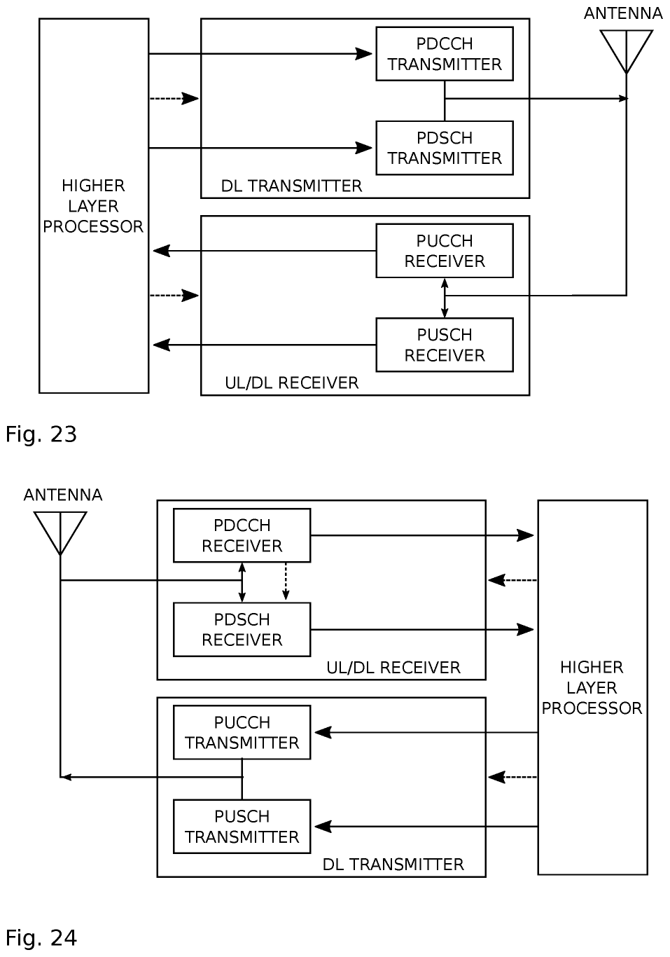

FIG. 23 is a block diagram illustrating one implementation of a gNB. The gNB may include a higher layer processor, a DL transmitter, a UL/DL receiver, and antennas. The DL transmitter may include a PDCCH transmitter and a PDSCH transmitter. The UL/DL receiver may include a PUCCH receiver and a PUSCH receiver. The higher layer processor may manage physical layer's behaviors (the DL transmitter's and the UL/DL receiver's behaviors) and provide higher layer parameters to the physical layer. The higher layer processor may obtain transport blocks from the physical layer. The higher layer processor may send/acquire higher layer messages such as an RRC message and MAC message to/from a UE's higher layer. The higher layer processor may provide the PDSCH transmitter transport blocks and provide the PDCCH transmitter transmission parameters related to the transport blocks. The UL/DL receiver may receive multiplexed uplink physical channels and uplink physical signals via receiving antennas and de-multiplex them. The PUCCH receiver may provide the higher layer processor UCI. The PUSCH receiver may provide the higher layer processor received transport blocks.

FIG. 24 is a block diagram illustrating one implementation of a UE. The UE may include a higher layer processor, a DL transmitter, a UL/DL receiver, and antennas. The DL transmitter may include a PUCCH transmitter and a PUSCH transmitter. The UL/DL receiver may include a PDCCH receiver and a PDSCH receiver. The higher layer processor may manage physical layer's behaviors (the DL transmitter's and the UL/DL receiver's behaviors) and provide higher layer parameters to the physical layer. The higher layer processor may obtain transport blocks from the physical layer. The higher layer processor may send/acquire higher layer messages such as an RRC message and MAC message to/from a UE's higher layer. The higher layer processor may provide the PUSCH transmitter transport blocks and provide the PUCCH transmitter UCI. The UL/DL receiver may receive multiplexed downlink physical channels and downlink physical signals via receiving antennas, and de-multiplex them. The PDCCH receiver may provide the higher layer processor DCI. The PDSCH receiver may provide the higher layer processor received transport blocks.

It should be noted that names of physical channels described herein are examples. The other names such as “New Radio (NR)PDCCH, NRPDSCH, NRPUCCH and NRPUSCH”, “new Generation-(G)PDCCH, GPDSCH, GPUCCH and GPUSCH” or the like can be used.

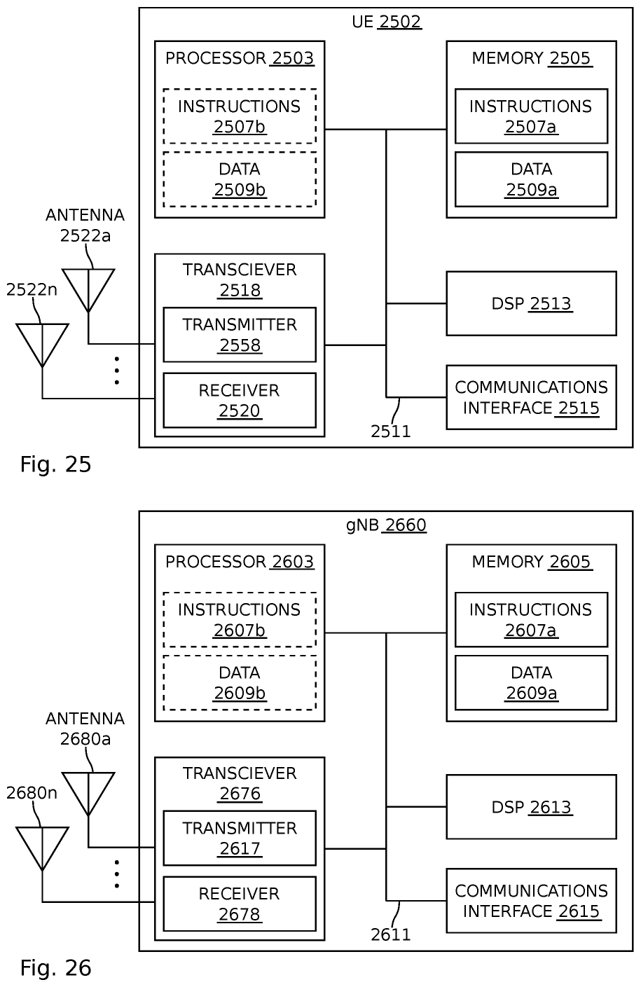

FIG. 25 illustrates various components that may be utilized in a UE 2502. The UE 2502 described in connection with FIG. 20 may be implemented in accordance with the UE 102 described in connection with FIG. 1. The UE 2502 includes a processor 2003 that controls operation of the UE 2002. The processor 2503 may also be referred to as a central processing unit (CPU). Memory 2505, which may include read-only memory (ROM), random access memory (RAM), a combination of the two, or any type of device that may store information, provides instructions 2507a and data 2509a to the processor 2603. A portion of the memory 2505 may also include non-volatile random access memory (NVRAM). Instructions 2507b and data 2509b may also reside in the processor 2503. Instructions 2507b and/or data 2509b loaded into the processor 2503 may also include instructions 2507a and/or data 2509a from memory 2505 that were loaded for execution or processing by the processor 2503. The instructions 2507b may be executed by the processor 2503 to implement the methods described above.

The UE 2502 may also include a housing that contains one or more transmitters 2558 and one or more receivers 2520 to allow transmission and reception of data. The transmitter(s) 2558 and receiver(s) 2520 may be combined into one or more transceivers 2518. One or more antennas 2522a-n are attached to the housing and electrically coupled to the transceiver 2518.

The various components of the UE 2502 are coupled together by a bus system 2511, which may include a power bus, a control signal bus and a status signal bus, in addition to a data bus. However, for the sake of clarity, the various buses are illustrated in FIG. 20 as the bus system 2511. The UE 2502 may also include a digital signal processor (DSP) 2513 for use in processing signals. The UE 2502 may also include a communications interface 2515 that provides user access to the functions of the UE 2502. The UE 2502 illustrated in FIG. 20 is a functional block diagram rather than a listing of specific components.

FIG. 26 illustrates various components that may be utilized in a gNB 2660. The gNB 2660 described in connection with FIG. 21 may be implemented in accordance with the gNB 160 described in connection with FIG. 1. The gNB 2660 includes a processor 2603 that controls operation of the gNB 2660. The processor 2603 may also be referred to as a central processing unit (CPU). Memory 2605, which may include read-only memory (ROM), random access memory (RAM), a combination of the two, or any type of device that may store information, provides instructions 2607a and data 2609a to the processor 2603. A portion of the memory 2605 may also include non-volatile random access memory (NVRAM). Instructions 2607b and data 2609b may also reside in the processor 2603. Instructions 2607b and/or data 2609b loaded into the processor 2603 may also include instructions 2607a and/or data 2609a from memory 2605 that were loaded for execution or processing by the processor 2603. The instructions 2607b may be executed by the processor 2603 to implement the methods described above.

The gNB 2660 may also include a housing that contains one or more transmitters 2617 and one or more receivers 2678 to allow transmission and reception of data. The transmitter(s) 2617 and receiver(s) 2678 may be combined into one or more transceivers 2676. One or more antennas 2680a-n are attached to the housing and electrically coupled to the transceiver 2676.

The various components of the gNB 2660 are coupled together by a bus system 2611, which may include a power bus, a control signal bus and a status signal bus, in addition to a data bus. However, for the sake of clarity, the various buses are illustrated in FIG. 21 as the bus system 2611. The gNB 2660 may also include a digital signal processor (DSP) 2613 for use in processing signals. The gNB 2660 may also include a communications interface 2615 that provides user access to the functions of the gNB 2660. The gNB 2660 illustrated in FIG. 21 is a functional block diagram rather than a listing of specific components.

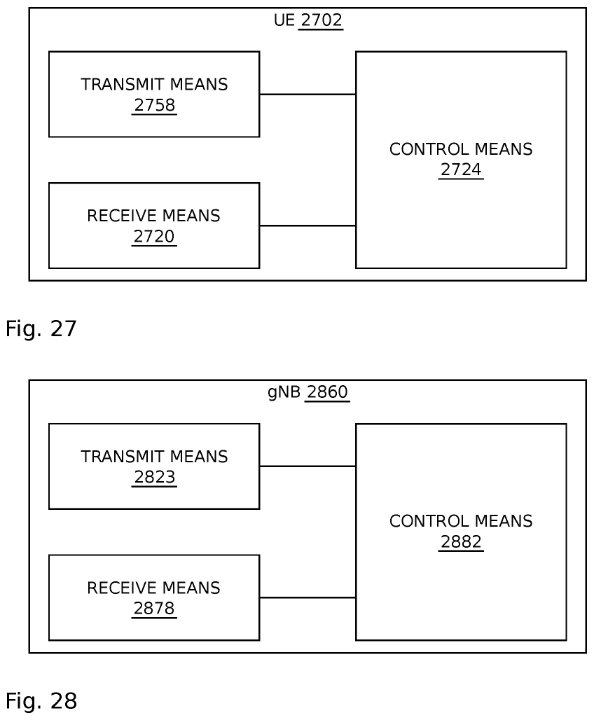

FIG. 27 is a block diagram illustrating one implementation of a UE 2702 in which systems and methods for a long PUCCH design for 5G NR operations may be implemented. The UE 2702 includes transmit means 2758, receive means 2720 and control means 2724. The transmit means 2758, receive means 2720 and control means 2724 may be configured to perform one or more of the functions described in connection with FIG. 1 above. FIG. 25 above illustrates one example of a concrete apparatus structure of FIG. 27. Other various structures may be implemented to realize one or more of the functions of FIG. 1. For example, a DSP may be realized by software.

FIG. 28 is a block diagram illustrating one implementation of a gNB 2860 in which systems and methods for a long PUCCH design for 5G NR operations may be implemented. The gNB 2860 includes transmit means 2817, receive means 2878 and control means 2882. The transmit means 2817, receive means 2878 and control means 2882 may be configured to perform one or more of the functions described in connection with FIG. 1 above. FIG. 26 above illustrates one example of a concrete apparatus structure of FIG. 28. Other various structures may be implemented to realize one or more of the functions of FIG. 1. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise random access memory (RAM), read-only memory (ROM), electrically erasable programmable memory (EEPROM), CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims. It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program. Furthermore, in a case where the programs are available on the market, the program stored on a portable recording medium can be distributed or the program can be transmitted to a server computer that connects through a network such as the Internet. In this case, a storage device in the server computer also is included.

Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. In a wireless communications network, a system for modifying extended idle-mode Discontinuous Reception (eDRX), the system comprising:
a base station;
a wireless terminal/user equipment (UE);
a Cellular Internet of Things (CIoT) Core Network (CN) node comprising:
a processor;
a non-transitory memory;
a Mobility Management Entity (MME) node stored in the non-transitory memory and enabled as a sequence of processor instructions, the MME receiving a downlinked message changing initial UE eDRX parameters to modified UE eDRX parameters, and packaging a eDRX change message encapsulating the modified UE eDRX parameters;
wherein the eDRX change message is downlinked to the UE;
wherein the UE replaces the initial eDRX parameters with the modified eDRX parameters in response to the eDRX change message; and,
wherein the UE and base station are in a connected mode.

2. The system of claim 1 wherein the MME receives the downlinked change message using special services in a Service Capability Exposure Function (SCEF) message; and,
wherein the MME packages the eDRX change message as part of a Non-Access Stratum (NAS) Detach Request message for transmission to the UE.

3. The system of claim 2 wherein the UE receives the NAS Detach Request message comprising an Information Element (IE) of modified eDRX parameters.

4. The system of claim 3 wherein the NAS Detach Request IE is a 6E Information Element Identifier (IEI).

5. The system of claim 1 wherein the modified eDRX parameters comprise an eDRX cycle and a Paging Time Window length.

6. The system of claim 1 wherein the MME receives the downlinked change message using special services in a SCEF message;
wherein the MME packages the eDRX change message as part of a UE Context Release message; and,
wherein the CN configures the UE Context Release message for transmission to the base station.

7. The system of claim 6 wherein the modified eDRX parameters, configured as part of the UE Context Release message, are encapsulated in a Radio Resource Control (RRC) Connection Release message by the base station; and,
wherein the RRC Connection Release message is transmitted to the UE by the base station.

8. The system of claim 1 wherein the MME receives the modified eDRX parameters using special services delivered by SCEF;
wherein the MME encapsulates the modified eDRX parameters as part of a dedicatedNASInfo message; and,
wherein the base station transmits a NAS DL (Downlink) Information Transfer message comprising the dedicatedNASInfo message to the UE.

9. The system of claim 8 wherein the MME packages the NAS DL Information Transfer message comprising eDRX IE parameters within the dedicatedNASInfo message.

10. The system of claim 9 wherein the dedicatedNASInfo message parameters comprise a modified Evolved Packet System Mobility Management (EMM) type message replacing an initial EMM type message, with the modified EMM type message comprising a eDRX notification.

11. The system of claim 10 wherein the eDRX notification comprises an Information Element Identifier (IEI) value; and,
wherein the Information Elements included in the modified eDRX IEI comprise Length of eDRX parameters, Paging Time Window length, and eDRX cycle value.

12. In a wireless communications network, a method for modifying extended idle-mode Discontinuous Reception (eDRX), the method comprising:
a Mobility Management Entity (MME) node, stored in the non-transitory memory of a Cellular Internet of Things (CIoT) Core Network (CN) node and comprising a sequence of processor instructions, receiving a downlinked message changing initial user equipment (UE) eDRX parameters to modified UE eDRX parameters;
the MME packaging an eDRX change message encapsulating the modified eDRX parameters;
downlinking the eDRX change message to the UE;
the UE replacing the initial eDRX parameters with the modified eDRX parameters in response to the eDRX change message; and,
the UE and a base station establishing a connected mode.

13. The method of claim 12 wherein the MME receiving the downlinked eDRX change message includes receiving the change message using special services in a Service Capability Exposure Function (SCEF) message; and,
wherein the MME packaging the eDRX change message includes packaging the eDRX change message as part of a Non-Access Stratum (NAS) Detach Request message for transmission to the UE.

14. The method of claim 13 wherein downlinking the eDRX change message to the UE includes the UE receiving the NAS Detach Request message comprising an Information Element (IE) of modified eDRX parameters.

15. The method of claim 12 wherein the modified eDRX parameters comprise an eDRX cycle and a Paging Time Window length.

16. The method of claim 12 wherein the MME receiving the downlinked change message includes the MME receiving the change message using special services in a SCEF message;
wherein the MME packaging the eDRX change message includes:
the MME packaging the eDRX change message as part of a UE Context Release message; and,
the CN configuring the UE Context Release message for transmission to the base station.

17. The method of claim 16 wherein downlinking the eDRX change message to the UE includes:
configuring the modified eDRX parameters as part of a UE Radio Resource Control (RRC) Connection Release message by the base station; and,
the base station transmitting the RRC Connection Release message to the UE.

18. The method of claim 12 wherein the MME receiving the modified eDRX parameters includes the MME receiving the modified eDRX parameters using special services delivered by SCEF;
wherein the MME packaging the modified eDRX parameters includes the MME packaging the modified eDRX parameters as part of a dedicatedNASInfo message; and,
wherein downlinking the eDRX change message to the UE includes the base station transmitting a NAS DL (Downlink) Information Transfer message comprising the dedicatedNASInfo message.

19. In a wireless communications network Cellular Internet of Things (CIoT) Core Network (CN) node comprising a non-transitory memory of processor executable instructions, a method for modifying extended idle-mode Discontinuous Reception (eDRX), the method comprising:
a Mobility Management Entity (MME) node, stored in the non-transitory memory, receiving a downlinked message changing initial UE eDRX parameters to modified user equipment (UE) eDRX parameters;
packaging an eDRX change message;
configuring the eDRX change message for downlink transmission to a UE.

20. The method of claim 19 wherein configuring the eDRX change message includes configuring the eDRX change message using a mechanism selected from the group consisting of a Non-Access Stratum (NAS) Detach Message, a Downlink (DL) Information Transfer Message, and a Radio Resource Control (RRC) Connection Release Message.
